(19) United States
(12) Patent Application Publication
(10) Pub. No.: US 2007/0274423 A1
(43) Pub. Date: Nov. 29, 2007

(54) Method for Monitoring the Synchronism of Transmitters in a Common Wave Network

(76) Inventors: Christoph Balz, Muenchen (DE); Martin Hofmeister, Muenchen (DE)

Correspondence Address: DITTHAVONG MORI & STEINER, P.C., 918 Prince St., Alexandria, VA, 22314, US

(21) Appl. No.: 10/572,027

(22) PCT Filed: Aug. 30, 2004
(86) PCT No.: PCT/EP04/09646

§ 371 Date: Mar. 21, 2007

(30) Foreign Application Priority Data
Sep. 11, 2003 (DE) 103 42 040.1

(51) Int. Cl. H04L 7/00

(52) U.S. Cl. 375/371; 375/E07.01

(57) ABSTRACT

A method for monitoring the time synchronization of a total of n transmitters in a common wave network is described in which a reference total pulse response is compared with a measured total pulse response belonging to the transmission channels of the n transmitters of the common wave network. A reference pulse response is fixed in the reference total pulse response in relation to the pilot pulse response, on the basis of which the remaining reference pulse responses are references to classify synchronization errors in the common wave network in various synchronization error categories.

### BACKGROUND OF THE INVENTION

The invention relates to a method for monitoring the synchronism of transmitters in a common wave network.

Transmission technology of terrestrial radio and television is based on a network of regionally distributed transmitters which transmit synchronously at the same transmitter frequencies (common wave network). The technology of common wave networks could only be achieved with the introduction of digital transmission methods in which, according to the transmission standard, protective intervals (guard intervals) are provided which make it possible to have a specific tolerance range for different transit times of the transmission signals from the individual transmitters because of different distances. Modern digital multicarrier methods (e.g. OFDM=orthogonal frequency division multiplexing) of digital radio (DAB=digital audio broadcasting) and of digital terrestrial television (DVB-T=digital video broadcasting terrestrial) are therefore based nowadays on common wave networks.

A functioning common wave network requires that each receiver of the common wave network receives an adequate signal level of the transmission signal at any arbitrary location within the transmission range of the common wave network and that the transmission signals received from the individual transmitters are synchronous within a specific tolerance range (protective or guard interval with DVB-T).

Because of the most varied of interferences—e.g. too little transmission power of a transmitter, defective synchronisation of a transmitter to the common wave network, different weather conditions in the transmission region of the common wave network etc.—the requirements of synchronism and adequate signal level can be unfulfilled for an interference-free reception in the common wave network. In addition, interfering signals from interfering transmitters and echo signals intruding into the common wave network can be superimposed upon the useful signals as a result of reflection of useful signals on obstacles. Constant monitoring with respect to synchronism and signal level of the received useful signal and also with respect to freedom from interfering signals in the entire transmission range must therefore be implemented. When infringement of these obligatory network requirements occurs, the interfering source—e.g. transmitter, supply route, obstacle—must be identified and a correct and functioning network operation must be produced again by corresponding remedial measures.

A method is presented in DE 196 42 633 A1 in which a transit time difference measurement between the receiving signals of two transmitters of the common wave network is implemented in order to determine the exact receiver location in a common wave network. Since the receiving signal includes not only the useful signal but also can contain echo signals, the latter must be identified and screened out. For unequivocal identification and screening out of occurring echo signals, the transmission characteristic of the transmission channels of both transmitters is determined by measurement of the channel impulse response.

In DE 199 37 457 A1, building on this method of transit time difference measurement, by determining the channel impulse response of the transmission channels of two transmitters of a common wave network, a method is described for monitoring transmitters in a common wave network. In order to determine the synchronism of the transmitters of a common wave network, the transit time differences respectively of two transmitters are hereby measured by a radio receiver and compared with a reference transit time difference of the same two transmitters. In the case of too great a deviation of the transit time differences which represents a lack of synchronism of the two tested transmitters, the transmitters subject to interference are informed by the radio receiver via a central office with respect to renewed synchronism.

The disadvantage of this method is the merely paired comparison of the transit times of two transmitters with respect to the synchronism of two transmitters relative to each other. The synchronism of a plurality of transmitters, in particular a transmitter group which is connected to the central office via a common supply route cannot be determined in this way. Reliable and unequivocal error source identification with respect to error sources which have an effect on only one single transmitter (e.g. phase detuning of a single transmitter) and error sources which have an effect on a transmitter group (e.g. transmission errors in the supply route to the transmitter group) cannot be achieved with this method.

Because of the merely paired comparison of the transit time differences of two receiving signals, the method has the further disadvantage that only relative asynchronism between two transmitters to be surveyed can be identified, whereas the absolute asynchronism of the respective transmitters relative to a reference transmitter and hence to the entire common wave network is not possible. If the transmitters to be surveyed have for example equal asynchronism relative to the reference transmitter, then they are synchronous relative to each other and are therefore by this method judged falsely as synchronous relative to the common wave network.

In the case of merely paired comparison of the transit time differences of the received useful signals of two transmitters, only one time-determining variable is used respectively for one transmitter—the receiving time of the received useful signal measured by the receiver. Taking into account a plurality of time-determining variables—for example the receiving times measured by the receiver of the echo signals associated with one transmitter—is not effected so that no additional information with respect to a more unequivocal and exact determination of the causal error source is possible in this way—e.g. time delay of the receiving signal due to a bad weather situation in a specific transmission area of the common wave network.

### SUMMARY OF THE INVENTION

A need therefore exists to develop a method for monitoring the synchronism of transmitters in a common wave network such that, on the one hand, unequivocal monitoring of the absolute synchronism of all the transmitters integrated in one common wave network is possible and, on the other hand, conclusions can be drawn from the measurement of an occurring asynchronism as unequivocally and easily as possible with respect to the error source or at least to the type of error source of the occurring asynchronism.

In contrast to the merely paired comparison of the synchronism of two transmitters, the reference impulse response of the strongest transmitter to the pilot impulse response is defined according to the invention on the basis of a reference measurement and all the remaining reference impulse responses of the remaining transmitters with respect to their synchronism relative to the common wave network are applied to the pilot impulse response within the framework of a transit time measurement. In this way, it is possible within the framework of a further measurement of all impulse responses associated with the individual transmitters—summation impulse response—to determine the number of asynchronous transmitters by comparison with all corresponding reference impulse responses—reference summation impulse response—and, dependent thereon, to determine the synchronism error class of the occurring synchronism error. The determination of the synchronism error class represents an important step with respect to identification of the synchronism error source or of the synchronism error type.

If only a temporal deviation between a measured impulse response and the associated reference impulse response occurs and hence asynchronism of only one transmitter relative to the common wave network, then in the case of a synchronism error of this type of the first synchronism error class, the error source in the respective transmitter can be located quite specifically.

In contrast, if time deviations occur between measured impulse response and associated reference impulse response in the case of a plurality of but not all remaining n−1 transmitters of the common wave network, then in the case of synchronism errors of this type of the second synchronism error class, synchronism error sources which relate to a transmitter group can be traced more specifically (e.g. transmission errors in a supply route to one transmitter group, bad weather area in a specific transmitter area etc.)

A time deviation between all n−1 remaining measured impulse responses and the associated reference impulse responses leads to a synchronism error of the third synchronism error class. In the case of synchronism errors of this type, possibly solely the strongest transmitter of the common wave network associated with the pilot impulse response can be detuned also with respect to level and also phase. This specific case can be determined via a correlation analysis between reference summation impulse response and summation impulse response.

In addition to monitoring the synchronism, the method can also be used to monitor the correct signal level of the individual transmitters of the common wave network. In the case of a deviation of the signal level of the measured impulse response relative to the reference impulse response, the transmitter power of the respective transmitter must be correspondingly adapted.

The individual reference impulse responses of the reference summation impulse response preferably have error tolerance ranges respectively in the dimension of time and of the signal level which classify a synchronous transmitter with adapted signal level if its measured impulse response is in this error tolerance range.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

An embodiment of the invention is represented in the drawing and described subsequently in more detail. There are shown:

FIG. 1 an overview representation of a common wave network;

FIG. 2 a graphic representation of the reference summation impulse response with error tolerance ranges;

FIG. 3 a graphic representation of the error tolerance ranges of the reference impulse responses, the measured impulse responses and interference impulses;

FIG. 4 a tabulated representation of the error tolerance ranges of the reference impulse responses, the measured impulse responses and interference impulses;

FIG. 5 a graphic representation of the effect of time windows of the Fourier transformation on identification of impulses;

FIG. 6a a graphic representation of intersymbol interferences in the case of a lack of synchronism of transmitters and

FIG. 6B a graphic representation of the summation impulse response after a synchronisation process.

### DESCRIPTION OF THE PREFERRED EMBODIMENT

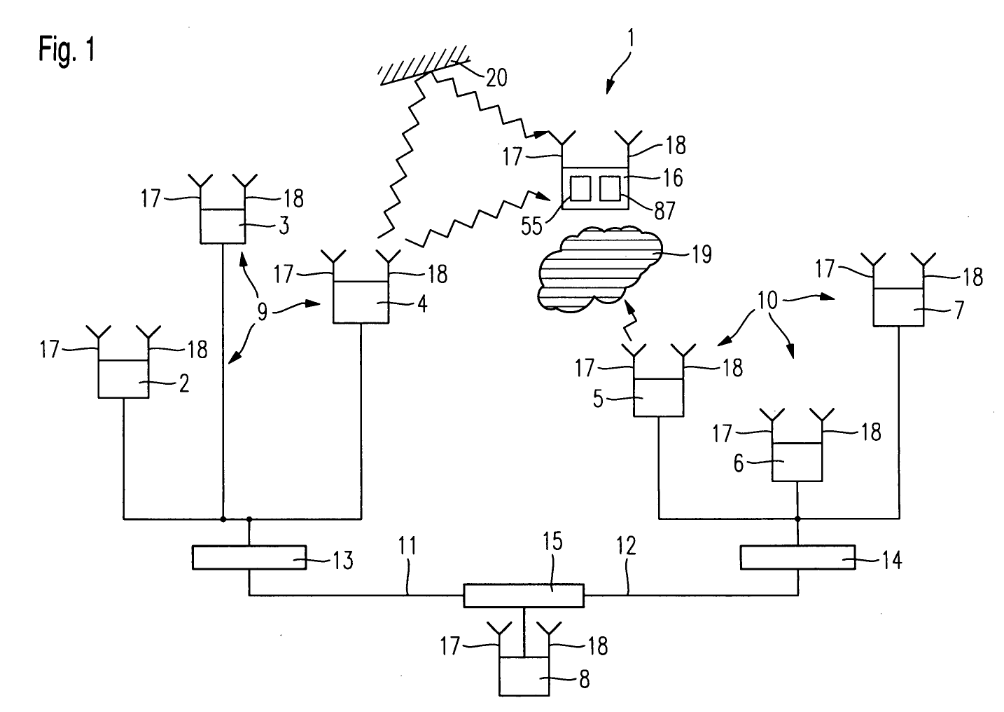

The method according to the invention for monitoring the synchronism of transmitters in a common wave network is described subsequently in an embodiment with reference to FIG. 1 to 6B.

According to FIG. 1, a common wave network 1 comprises for example the transmitters 2, 3, 4, 5, 6 and 7, which are distributed in the transmitter region and a central office 8. In this exemplary common wave network 1, the transmitters 2, 3 and 4 are combined into a first transmitter group 9 and the transmitters 5, 6 and 7 into a second transmitter group 10. The first transmitter group 9 is connected to the central office 8 via a first common supply route 11, whilst the second transmitter group 10 is connected likewise to the central office 8 via the second common supply route 12. The coupling of the transmitters 2, 3 and 4 to the first supply route 11 is effected via a first distribution device 13, whilst the coupling of the transmitters 5, 6 and 7 to the second supply route 12 is effected via a second distribution device 14. The central office 8 couples in a coupling device 15 into the first supply route 11 and into the second supply route 12. A receiving device 16 is used to measure and monitor the common wave network 1. The receiving device 16 can be used in a stationary or portable manner, a reference impulse measurement of the individual transmitters requiring to be implemented for each new location with respect to level and phase in the case of a portable receiving device. The transmitters 2, 3, 4, 5, 6 and 7 and also the central office 8 and receiving device 16 are fitted respectively with a receiving antenna 17 and a transmitting antenna 18. In the represented example, the feedback from the receiving device 16 at the central office 8 is effected by wireless. If this feedback is effected via a line, the transmitting antenna 18 can be dispensed with there.

The receiving device 16 serves on the one hand to identify areas in the transmission range of the common wave network 1 which have either absolutely no reception or only too weak reception for example because of obstacles 19 in the transmission channel between transmitter and receiver. Echoes due to reflections of the transmission signal on large-area bodies 20 (e.g. mountains) can also be detected with a receiving device 16 of this type. In the case of interference of this type, remedial measures can for example be repositioning or adjustment of the transmitting power of individual transmitters.

In addition to these tasks of monitoring the signal level of the transmission signal and the generation of echo signals, the receiving device 16 also implements measurement and monitoring of the synchronism of the transmitters 2, 3, 4, 5, 6 and 7 which are integrated in the common wave network 1.

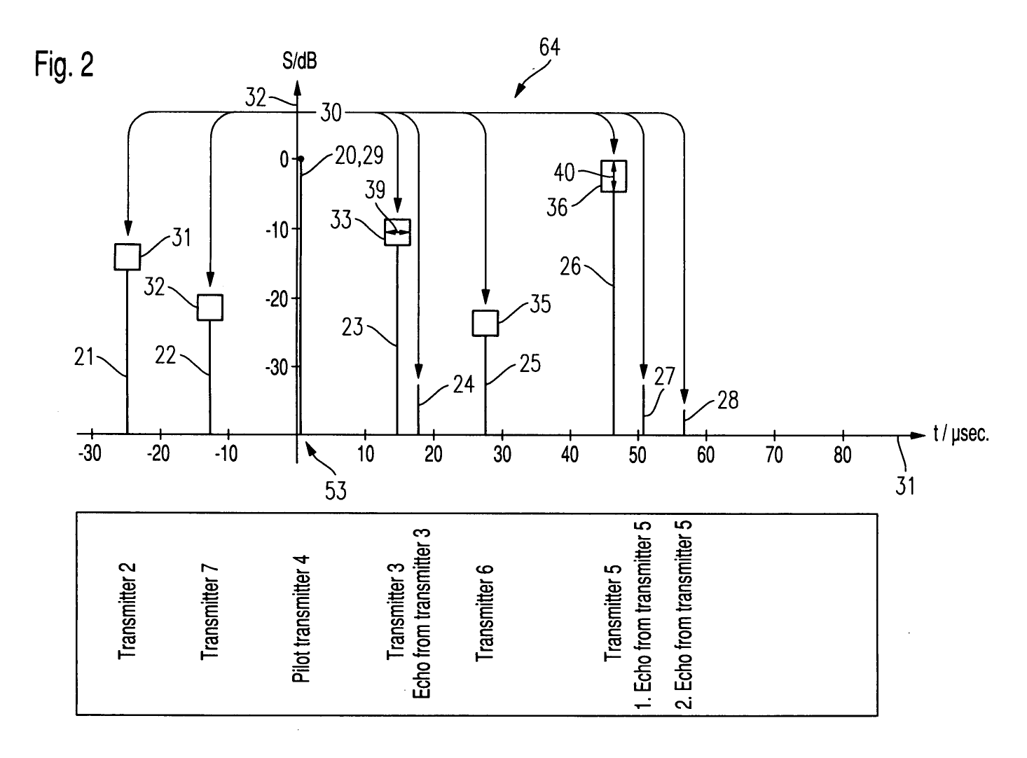

According to the method according to the invention, the receiving device 16 is positioned at selected positions within the transmission range of the common wave network 1. For each of these positions, the impulse response for the corresponding transmission channel from the transmitter to the receiving device 16 is determined for each transmitter 2, 3, 4, 5, 6 and 7 of the common wave network 1 by the receiving device 16. This can be effected for example by means of pilot carriers (scattered pilot) in the case of a DVB-T signal, as is known fundamentally from DE 100 05 287 A1. The first measurement of the impulse response serves as reference measurement for subsequent measurements. The impulse response determined in the first measurement represents therefore a reference impulse response. The reference impulse responses of all transmission channels associated with the transmitters 2, 3, 4, 5, 6 and 7 are represented as reference summation impulse response 30 in the form of an echo pattern according to FIG. 2 in time-dependent graphics 64 of a graphics system 55 which is integrated in the receiving device 16 or in a device connected to the receiving device 16 - for example a personal computer connected via internet to the receiving device 16.

The reference impulse response 20 of the strongest transmitter—for example transmitter 4—is defined as pilot impulse 29 in order to determine the relative temporal displacement of the remaining reference impulse responses 21 (transmitter 2), 22 (transmitter 7), 23 and 24 (transmitter 3), 25 (transmitter 6), 26, 27 and 28 (transmitter 5) at any reference point, the pilot impulse. As reference point for the remaining reference impulse responses 21, 22, 23, 24, 25, 26, 27 and 28, the pilot impulse 29 is set at the origin of the coordinate system 53 of the graphics 64, comprising the abscissa 31 and the ordinate 32. The abscissa 31 forms the receiving time of the reference impulse response in the dimension of microseconds or in the distance dimension of kilometres or miles corresponding thereto. The ordinate 32 represents the signal level of the reference impulse response relative to the signal level of the pilot impulse 29 in the dimension of decibels.

Because of the temporal referencing of the remaining reference impulse responses 21, 22, 23, 24, 25, 26, 27 and 28 to the pilot impulse 29, pre-echoes are produced which represent reference impulse responses which are received by the receiving device 16 temporally before the pilot impulse 29 (reference impulse responses 21 and 22). Analogously, post-echoes are produced which are received as reference impulse responses by the receiving device 16 temporally after the pilot impulse 29 (reference impulse responses 23, 24, 25, 26, 27 and 28).

Since the reference summation impulse response 30 for subsequent measurements of impulse responses by the receiving device 16 serve as reference echo pattern and subsequent measurements of the impulse responses, also in the case of exact synchronism of the participating transmitters 2, 3, 4, 5, 6 and 7, are associated with a specific deviation between the reference impulse responses and the measured impulse responses, introduction of a specific error tolerance range 31, 32, 33, 34, 35, 36, 37 and 38 about the respective ideal value pair, reference receiving time and reference signal level of the respective reference impulse response 21, 22, 23, 24, 25, 26, 27 and 28, is recommended. Hence an individual error tolerance range 31, 32, 33, 34, 35, 36, 37 and 38 is defined by the operator of the receiving device 16 for each reference impulse response 21, 22, 23, 24, 25, 26, 27 and 28, said error tolerance range preferably comprising an error tolerance band 39 in the time dimension and an error tolerance band 40 in the signal level dimension. However an error tolerance band 39 in the time dimension can suffice.

In a measurement subsequent to the reference measurement, in turn the impulse responses 41, 42, 43, 44, 45, 46, 47 and 48 of the transmitters 2, 3, 4, 5, 6, 7 and 8 of the common wave network 1 are received by the receiving device 16 and mapped as summation impulse response 52 in the coordinate system 53 of new time-dependent graphics 65 of the graphics system 55 in such a manner that the measured impulse response 53 of the strongest transmitter 4 comes to lie precisely at the origin of the coordinate system 53 of the new graphics 65.

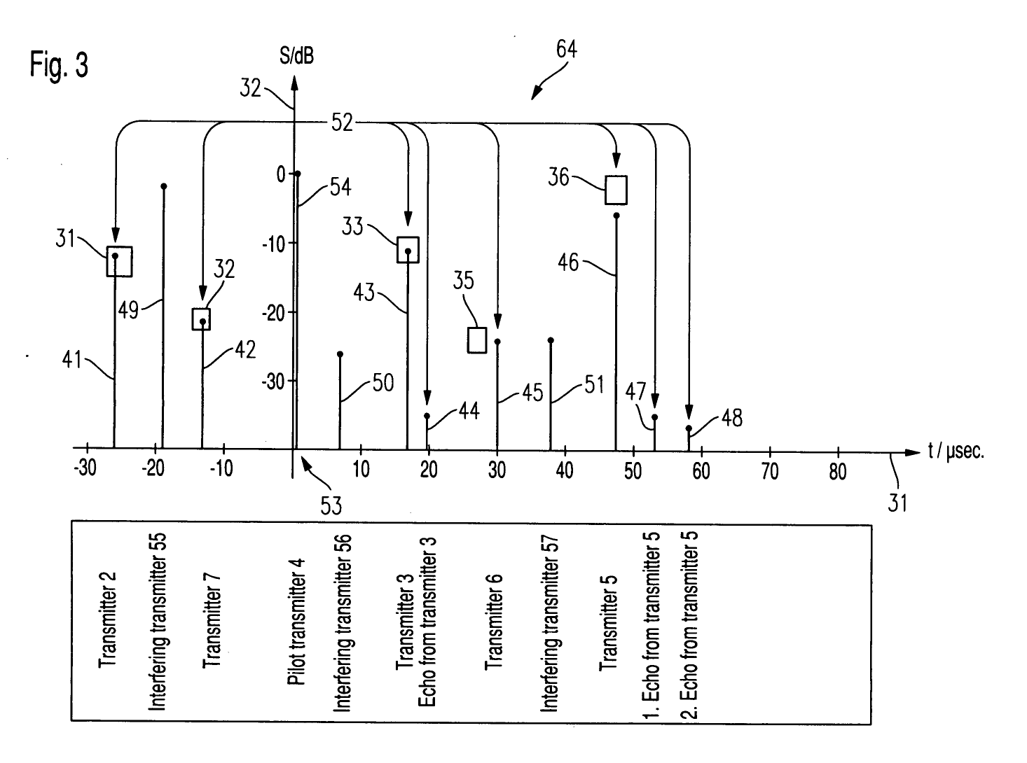

In addition to the measured impulse responses 41, 42, 43, 44, 45, 46, 47 and 48 of the transmitters 2, 3, 4, 5, 6, 7 and 8 of the common wave network 1, also interfering impulses 49, 50 and 51 are also measured by the receiving device 16, said interfering impulses being generated for example by transmitters 55, 56 and 57 from neighbouring cells and intruding in the transmission range of the common wave network 1. These are likewise mapped in the coordinate system 53 of the new graphics 65 of the graphics system 55 corresponding to their receiving time and their signal level. Since the error tolerance ranges 31, 32, 33, 34, 35, 36, 37 and 38 of the reference impulse responses 21, 22, 23, 24, 25, 26, 27 and 28 of the reference measurement are likewise mapped according to FIG. 3 in the coordinate system 53 of the new graphics 65 of the graphics system 55, the operator of the receiving device 16 can identify the impulse responses which lie outwith the defined error tolerance range of the corresponding reference impulse responses relatively easily.

In the exemplary measurement which is illustrated in FIG. 3, a no longer tolerable time displacement between reference impulse response and measured impulse response occurs in the impulse response 45, from which a conclusion can be drawn with respect to the synchronism error between the strongest transmitter 4 and the transmitter 6.

In addition, in the exemplary measurement illustrated in FIG. 3, it is evident that the signal level of the measured impulse response 46 appears outwith the tolerable error tolerance range 36, in particular below the error tolerance band 40 in the signal level dimension of the error tolerance range 36. The signal level of the impulse response 46 which is too low relative to the signal level of the associated reference impulse response 26 can for example be attributed to too low a transmission power of the transmitter 5 or too great attenuation of the transmission signal from the transmitter 5 to the receiving device 16 because of for example a bad weather period in the transmission channel from the transmitter 5 to the receiving device 16.

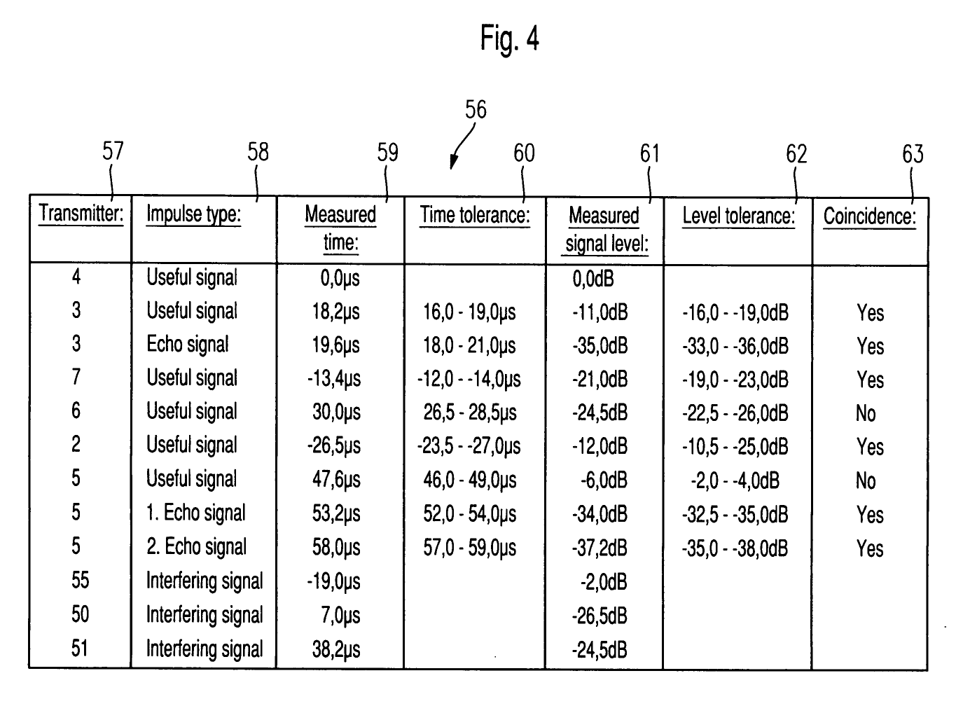

In addition to the graphic representation of the summation impulse response 30 in graphics 65 of the graphics system 55, also a representation of all received impulse responses 41, 42, 43, 44, 45, 46, 47 and 48 and of all interfering impulses 49, 50 and 51 is possible in a Table 56 according to FIG. 4, said table being produced and constantly updated by a processing system 87 in the receiving device 16. Table 56 contains the following columns:
Column 57 with the title of the transmitter of the received impulse,
Column 58 with the type of received impulse (useful signal, echo signal, interfering signal),
Column 59 with the measured receiving time of the received impulse,
Column 60 with the error tolerance limits, defined by the operator, of the receiving time of the received impulse,
Column 61 with the measured signal level of the received impulse in relation to the signal level of the pilot impulse,
Column 62 with the error tolerance limits defined by the operator of the signal level of the received impulse and
Column 63 with a statement relating to the coincidence between measured impulse and error tolerance range of the corresponding reference impulse.

In Table 56 in FIG. 4, the corresponding values of the exemplary measurement are plotted in the graphic representation of FIG. 3.

Those impulse responses respectively which do not fall temporally into the error tolerance ranges of the corresponding reference impulse responses are identified for each measuring process by the processing unit 57 of the receiving device 16.

If only one single impulse response of the measurement is detected outside the respective error tolerance range, then there is a high probability that the corresponding transmitter is not synchronised with the common wave network 1. A synchronism error of this type concerns an error of the first synchronism error class. Accordingly, if a deviation relative to the respective error tolerance range is established by the processing unit 57 only in the case of a measured impulse response, then this synchronism error is assigned to the first synchronism error class and a corresponding first alarm A1 is set off.

If in the case of a common wave network with n transmitters the n−1 impulse responses measured in addition to the pilot impulse response are monitored with respect to their coincidence with the corresponding error tolerance ranges by the processing unit 57 and if in the case of at least two and simultaneously less than n−1 of these impulse responses a lack of coincidence is produced, then there is a synchronism error of the second synchronism error class. This is established by the processing unit 57 and a corresponding second alarm A2 is set off. A synchronism error of the second synchronism error class can concern an error in a transmitter group, for example the first transmitter group 9 or the second transmitter group 10 of FIG. 1. By means of the transmitter identification of the measured impulse responses of the summation impulse response 52, a synchronism error of this type of one transmitter group can be identified.

If in the case of a common wave network with n transmitters all n−1 impulse responses do not fall into the corresponding error tolerance ranges, then the transmitters of all n−1 impulse responses can be synchronous with each other, whilst the strongest transmitter of the common wave network, the impulse response of which serves as pilot impulse response of the common wave network, transmits asynchronously relative to the common wave network. This special case is identified by a correlation analysis between the measured n−1 impulse responses and the corresponding n−1 reference impulse responses. If the result thereby is a correlation between the measured n−1 impulse responses and the corresponding n−1 reference impulse responses, then this special case of a synchronism error is present which leads to classification in the third synchronism error class and to triggering of a third alarm A3 by the processing unit 57.

The alarms A1 to A3 are supplied together with the corresponding measured echo patterns according to FIG. 3 by the receiving device 16 to the central office 8 in order to implement there corresponding evaluations and analyses for concrete error location and, building thereon, to implement corresponding remedial measures to synchronise all the transmitters 2, 3, 4, 5, 6 and 7 of the common wave network 1 in the range of the transmitter 2, 3, 4, 5, 6 and 7, of the supply routes 11 and 12 etc.

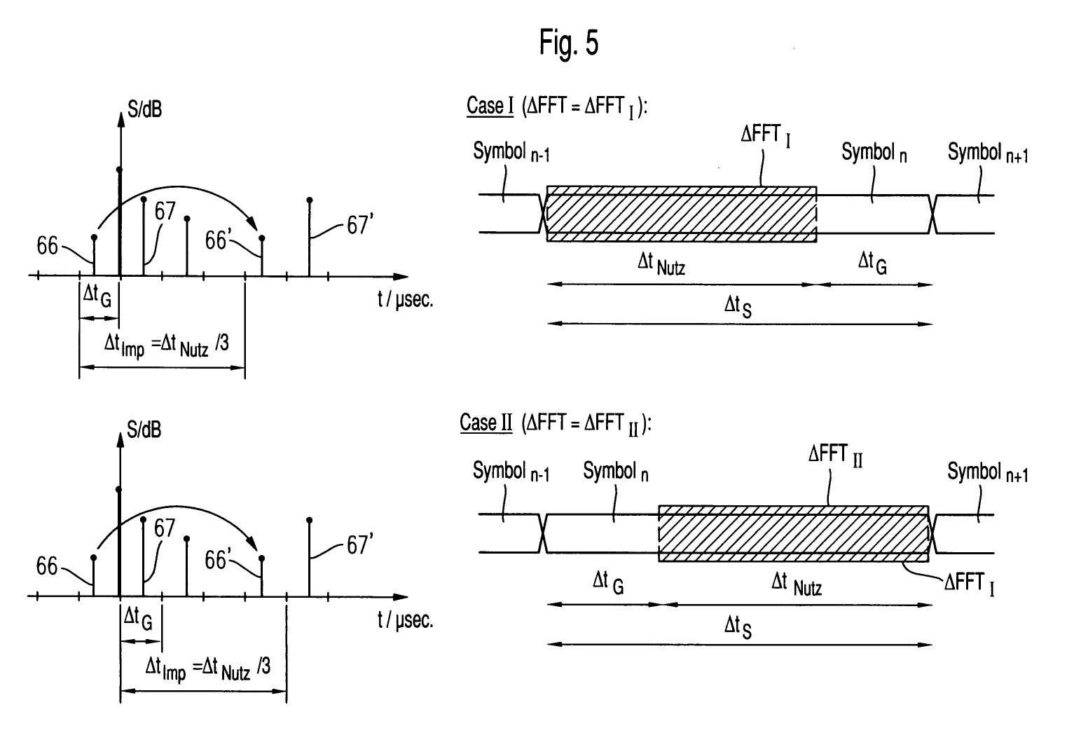

Determination of the summation impulse response 65 is effected in general by an inverse Fourier transformation from the transmission function of the transmission channel which is produced by the sum of the signals of all the transmitters 2, 3, 4, 5, 6 and 7 participating in the common wave network 1. The incentive for the transmission channels to determine the summation impulse response 65 is effected by so-called pilot carriers (scattered pilots) which, on average for example with DVB-T in each third carrier, are disposed in a transmission frame of the OFDM-modulated transmission signal and are modulated individually by a 2-PSK-modulation—in contrast to the QAM-modulated useful data carriers. The summation impulse response 65 has a periodic temporal course since the frequency spectrum of the summation impulse response 65 is present periodically scanned only at the pilot carriers in the frequency range. Since pilot carriers occur only in each third carrier, the carrier spacing between the pilot carriers is higher by the factor 3 than the carrier spacing Δf_{T} between each individual carrier. Consequently, the permissible time range of the summation impulse response ΔT_{Imp} relative to the useful interval ΔT_{Nutz} of an OFDM-modulated transmission signal is smaller by a factor 3 (Δt_{Imp}=Δt_{Nutz}/3=1/(3*Δf_{T})). The permissible time range of the summation impulse response Δt_{Imp} can, in the case of alternative methods for determining the summation impulse response 65, adopt other values (when determining the summation impulse response 65 by means of inverse Fourier transformation from the FIR and IIR filter coefficient of an equaliser integrated in the receiving device 16, the permissible time range Δt_{Imp} is produced from the filter length of the FIR and IIR filters). In order to avoid intersymbol interferences due to transit time differences, a protective interval Δt_{G} is defined which emerges from the useful interval Δt_{Nutz} according to FIG. 5 and in which no evaluation of the superimposition signal is effected by the receiving devices 16.

The time window ΔFFT of the discrete Fourier transformation for determining the discrete summation impulse response 65 corresponds to the duration of the useful interval Δt_{Nutz} of an OFDM-modulated transmission signal. Because of varying positioning of the time window ΔFFT of the discrete Fourier transformation within the total symbol length Δt_{S} of an OFDM-modulated transmission signal (Δt_{S}=Δt_{G}+Δt_{Nutz}), the result can be different relative positions between the permissible time range of the summation impulse response Δt_{Imp} and the protective interval Δt_{G}.

In the extreme case I (ΔFFT=ΔFFT₁), the time window ΔFFT covers the beginning of the entire symbol length Δt_{S}, whilst the protective interval Δt_{G} covers the end of the entire symbol length Δt_{S}. In this case, pre-echoes, in FIG. 5 for example the impulse response 66, do not lead to intersymbol interferences since the impulse response 66 was detected as a pre-echo and is situated in the protective interval Δt_{G}. If as a result impulse responses which represent pre-echoes with respect to the strongest power impulse response (at 0 dB, 0 μs) are expected in the summation impulse response 65, then the positioning of the time window ΔFFT is chosen as in the extreme case I.

In the normal case (case II: ΔFFT=ΔFFT_{II}), the time window ΔFFT covers the end of the symbol length Δt_{S}, whilst the protective interval Δt_{G} covers the beginning of the symbol length Δt_{S}. Post-echoes, in FIG. 5 for example the impulse response 67, do not lead to intersymbol interferences since the impulse response 67 is situated in the protective interval Δt_{S}. If consequently impulse responses which represent post-echoes with respect to the strongest power impulse response (0 dB, 0 μs) are expected in the summation impulse response 65, then the positioning of the time window ΔFFT is chosen as in case II.

If consequently with a set error tolerance range in the pre-echo range, for example error tolerance ranges 31 and 32 in FIG. 3, a corresponding impulse response, for example impulse response 41 and 42 in FIG. 3, is not registered by the receiving devices 16 because either the corresponding signal level is too weak or not present at all, then as a result of the method according to the invention for monitoring the synchronism of transmitters in a common wave network, in addition to the error tolerance ranges 31 or 32 corresponding error tolerance ranges are set at points in time which are displaced temporally forwards exactly by the period length of the summation impulse response 65 (=Δt_{Imp}) relative to the pre-echo points in time and function in the permissible time range of the summation impulse response Δt_{Imp} as error tolerance ranges. In this way, the echoes, which come to lie in the permissible time range of the summation impulse response Δt_{Imp} when choosing the time window ΔFFT corresponding to the extreme position ΔFFT_{II}, said echoes corresponding to the pre-echoes lying outwith the permissible time range Δt_{Imp} of the summation impulse response 65 because of the periodicity of the summation impulse response 65, can be identified reliably and unequivocally by the receiving device 16.

If a constructed common wave network 1 has not yet been balanced, the result can be error interpretations of the temporal position of the impulse response 69 lying outside the permissible time range Δt_{Imp} because of the periodicity of the summation impulse response 65. An impulse response 69 lying outside the permissible time range is repeated in the permissible time range Δt_{Imp} as impulse response 69′ or 69″ because of the periodicity of the summation impulse response. Since these repeated impulse responses 69′ and 69″ lie within the intersymbol interference-free time range Δt_{G}, the delay of this impulse response is interpreted erroneously as insignificant although the original impulse response 69 leads to an intersymbol interference.

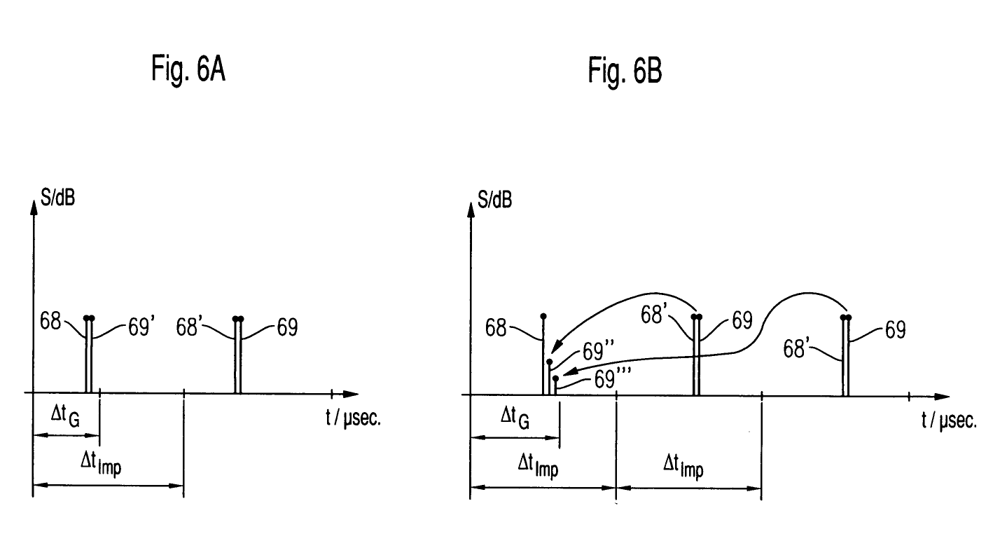

This undesired intersymbol interference can be eliminated or detected by temporal displacement of the transmission signal of the transmitter which leads to the impulse response 69. The temporal displacement is chosen thereby so large that the impulse response falls into the time range of the protective interval Δt_{G}. The delay of the transmission signal into the range outside the permissible time range Δt_{Imp} of the summation impulse response 65 effects, as represented in FIG. 6B, a reduction in the signal level of the impulse response 69″ folded in the permissible time range Δt_{Imp} in the measurement of the impulse response. If a time displacement of the impulse response 69 by two periods occurs, then the signal level of the impulse response 69′″ which is displaced temporally into the permissible time range Δt_{Imp} of the summation impulse response 65 is reduced in addition.

A false interpretation of the temporal delay of an impulse response can be detected also by the modulation error rate MER (modulation error rate=20 * log (average amount of the symbol amplitude/average amount of the error amplitude)). If the delay of an impulse response lies within the protective interval Δt_{G}, this can be compensated for by the channel estimation and the modulation error rate has a high value corresponding to the other signal quality. If however the delay of the impulse response lies outside the protective interval, the modulation error rate deteriorates.

The invention is not restricted to the illustrated embodiment. It is suitable not only for OFDM-modulated multicarrier methods, such as DAB and DVB-T but also for single carrier methods, e.g. for VSB (Vestigial Side Band) methods of the ATSC standard which is used in North America for digital television broadcasting. In addition, all the above-described features can be combined with each other in any manner.

While the present invention has been described in connection with a number of embodiments and implementations, the present invention is not so limited but covers various obvious modifications and equivalent arrangements, which fall within the purview of the appended claims.

1. A method for monitoring the synchronism of in total n transmitters in a common wave network, comprising:
comparing a reference summation impulse response of transmission channels associated with the n transmitters of the common wave network with a measured summation impulse response of the transmission channels associated with the n transmitters of the common wave network;
establishing a reference impulse response in the reference summation impulse response to the a pilot impulse response; and
referencing remaining reference impulse responses to the pilot impulse response, to classify synchronism errors occurring in the common wave network into a plurality of synchronism error classes.

2. A method for monitoring the synchronism according to claim 1,
wherein:
the pilot impulse response includes a reference impulse response in the reference summation impulse response with the highest signal level.

3. A method for monitoring the synchronism according to claim 2,
further comprising:
assigning the reference level 0 dB to the pilot impulse response.

4. A method for monitoring the synchronism according to claim 3,
further comprising:
displacing the measured summation impulse response temporally until an impulse response of the measured summation impulse response with the highest signal level is synchronous with the pilot impulse response of the reference summation impulse response.

5. A method for monitoring the synchronism according claim 1,
further comprising:
for each reference impulse response in the reference summation impulse response apart from the pilot impulse response, defining an error tolerance range having an error tolerance band in the dimension of time and/or an error tolerance band in the dimension of the signal level.

6. A method for monitoring the synchronism according to claim 5,
further comprising:
determining that at least one synchronism error of the transmitters is present in the common wave network as soon as at least one impulse response of the measured summation impulse response lies outside the error tolerance range of the corresponding reference impulse response of the reference summation impulse response.

7. A method for monitoring the synchronism according to claim 6,
further comprising:
determining a synchronism error of a first synchronism error class is present if precisely one impulse response of the measured summation impulse response lies outside the error tolerance range of the corresponding reference impulse response of the reference summation impulse response.

8. A method for monitoring the synchronism according to claim 7,
further comprising:
determining a synchronism error of a second synchronism error class is present if at least two and simultaneously less than n−1 of the in total n impulse responses of the measured summation impulse response lie outside the error tolerance range of the corresponding reference impulse response of the reference summation impulse response.

9. A method for monitoring the synchronism according to claim 8,
further comprising:
determining a synchronism error of a third synchronism error class is present if precisely n−1 of the in total n impulse responses of the measured summation impulse response lie outside the error tolerance range of the corresponding reference impulse response of the reference summation impulse response and a positive correlation between the n−1 reference impulse responses and the n−1 measured impulse responses is detected.

10. A method for monitoring the synchronism according to claim 9,
further comprising:
upon a synchronism error occurring, triggering an alarm corresponding to the respective synchronism error class.
